(19) United States
(12) Patent Application Publication
(10) Pub. No.: US 2001/0030941 A1
(43) Pub. Date: Oct. 18, 2001

(54) Resource availability in an IP-based network

(76) Inventors: Niilo Musikka, Bromma (SE); Lennart Rinnback, Jarfalla (SE); Lars Linden, Hastveda (SE); Lars B. Johansson, Linkoping (SE)

Correspondence Address: Richard J. Moura, Jenkens & Gilchrist. P.C., 3200 Fountain Place, 1445 Ross Avenue, Dallas, TX, 75202, US

(21) Appl. No.: 09/745,693

(22) Filed: Dec. 22, 2000

Related U.S. Application Data
(60) Provisional application No. 60/177,830, filed on Jan. 25, 2000.

(51) Int. Cl. H04L 1/00

(52) U.S. Cl. 370/221; 370/328; 455/422

(57) ABSTRACT

A method and system are provided for configuring a mobile communications network, such as for example, in an IP-based Base Station System, to ensure high availability of network elements especially during catastrophic events.

### BACKGROUND OF THE INVENTION

1. Technical Field of the Invention

The present invention relates in general to the mobile telecommunications field and, in particular, to a method and system for improving the availability of network elements in an Internet Protocol-based (IP-based) system, including but not exclusively limited to, a network in an IP-based Base Station System (BSS).

2. Description of Related Art

FIG. 1 is a block diagram of an IP-based BSS 100, which is disclosed in the above-described commonly-assigned, copending U.S. application for patent Ser. No. 09/494,606, the entire disclosure of which is incorporated herein by reference. As shown, such an IP-based BSS 100 can include three types of nodes connected to an IP network 108. A first node connected to the IP network 108 is an RBS 102. In general, the RBS 102 functions similarly to existing RBSs used for implementing a Global System for Mobile Communications (GSM) model. Moreover, the RBS 102 also provides IP support for the BSS 100. For example, the RBS 102 functions as an IP host and can include an IP router (not shown). The IP router can be used to route payload User Datagram Protocol (UDP) datagrams to one or more Transmitter/Receivers (TRXs) and also for connecting a plurality of RBSs in various topologies.

A second node connected to the IP network 108 is a GateWay (GW) 104. The GW 104 can be used to terminate the A-interface. Also, the GW 104 can perform a conversion from one protocol (e.g., SS7 protocol) to another protocol (e.g., Transmission Control Protocol (TCP)/IP). The GW 104 can also include a Media GW (MGW) which functions similarly to existing Transcoder Controllers in an Ericsson implementation of the GSM model. The MGW (not shown) includes a pool of Transcoder/Rate Adaptor (TRA) devices (not shown), which, when allocated, are connected to the A-interface. However, the IP network (e.g., GSM) side of the TRAs in the MGW are connected to respective UDP ports. Preferably, the GW 104 is connected to the IP network 108 via a separate router (not shown).

A third node connected to the IP network 108 is a Radio Network Server (RNS) 106. The RNS 106 functions similarly to a Base Station Controller (BSC) used for implementing a GSM model. A primary difference between the RNS 106 and a BSC is that the RNS does not switch payloads and does not include a Group Switch (GS). As such, the RNS 106 preferably carries signalling only, and can include a pool of processors (e.g., the number of processors determined by capacity requirements). The RNS 106 provides a robust, general purpose distributed processing environment, which can be based on a standard operating system such as, for example, SUN Solaris™. The RNS 106 can serve one or more logical BSCs and is preferably connected to the IP network 108 via a separate router.

As shown in FIG. 1, the payload is routed directly between the GW 104 and RBS 102, without passing through the RNS' 106 processors. The A-interface signalling is routed between the RNS 106 and GW 104, and the Abis interface signalling is routed between the RNS 106 and the RBS 102. A GW control protocol (not shown) is provided between the RNS 106 and the GW 104.

As described above, certain routers can be located at the physical nodes shown in FIG. 1 and respectively connected to the IP network 108. Also, other routers can be located at hub sites. The routers function as concentrators for payload and signalling and thereby provide trunking gain. As such, the application software running in the respective nodes needs no information about the transmission infrastructure, and only the addresses of the signalling and payload endpoints are known. Consequently, the transmission infrastructure can be efficiently used with relatively low complexity. Also, in addition to the transmission efficiency gained by the IP-based BSS shown in FIG. 1, the separation of the payload and signalling information provides a technology-based separation of the RNS and GW functionality. As such, the RNS 106 can handle relatively high-level traffic control functions, advanced radio network algorithms, and network administration functions, while the GW 104 can handle relatively low-level, real-time media stream conversions.

A significant problem that exists for all mobile communications network operators, including operators of existing and future IP-based networks, is to be able to ensure that the network resources remain operable. In fact, most network operators require a relatively high availability of network elements. Typically, certain network elements carry substantial amounts of traffic, and an operator can lose significant amounts of revenue if a critical network element fails or becomes inoperable. As such, certain network elements can be made fault tolerant (internally) to a certain extent by the use of redundant components. However, this type of (internal) redundancy does not prevent a network element from becoming inoperable as the result of certain catastrophic events, such as, for example, fires, earthquakes, power failures, permanent link failures, and the like. Consequently, a significant need exists for a method and system that can ensure a relatively high availability of network elements in an IP-based system especially during catastrophic events.

### SUMMARY OF THE INVENTION

In accordance with a preferred embodiment of the present invention, a method and system are provided for configuring an IP-based mobile communications network, such as for example, in an IP-based BSS, to ensure high availability of network elements especially during catastrophic events.

An important technical advantage of the present invention is that a relatively high availability of network resources can be provided even during catastrophic events.

Another important technical advantage of the present invention is that a method and system are provided for improving operator maintainability of network resources.

Yet another important technical advantage of the present invention is that a method and system are provided for reducing operator revenue losses.

Still another important technical advantage of the present invention is that a method and system are provided that reduces the need for fault tolerant nodes, which results in lower cost nodes.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 is a block diagram of an IP-based BSS, which can be used to illustrate an existing problem; and

FIGS. 2A and 2B are related block diagrams of an exemplary IP-based BSS, which can be used to implement a preferred embodiment of the present invention.

### DETAILED DESCRIPTION OF THE DRAWINGS

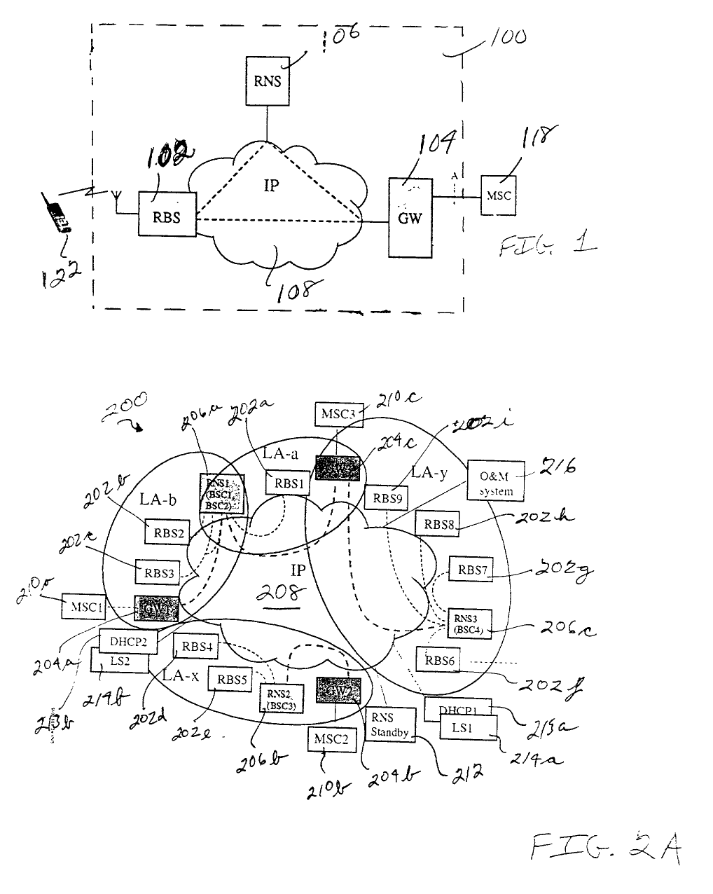

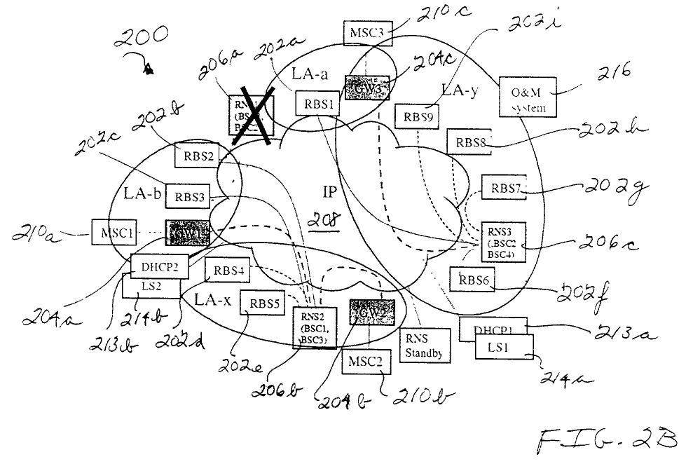

The preferred embodiment of the present invention and its advantages are best understood by referring to FIGS. 1-2B of the drawings, like numerals being used for like and corresponding parts of the various drawings.

Essentially, in accordance with a preferred embodiment of the present invention, a method and system are provided for configuring a mobile communications network, such as for example, in an IP-based BSS, to ensure high availability of network elements especially during catastrophic events.

Specifically, FIGS. 2A and 2B are related block diagrams of an exemplary IP-based BSS 200, which can be used to implement a preferred embodiment of the present invention. Referring to FIG. 2A, BSS 200 includes a plurality of network elements which are coupled to an IP network 208. For example, a plurality of RBSs 202a-i are coupled to the IP network 208. For this exemplary embodiment, each such RBS functions as an IP host and can include an IP router. BSS 200 also includes three RNSs 206a-c. Each such RNS is responsible for controlling the operations of certain RBSs. For example, as illustrated by the smaller dashed lines (signalling links) shown in FIG. 2A, RNS1 206a controls the operations of RBSs 202a-c. The RNSs 206a-c are also coupled to and control one or more GWs 204a-c. For example, RNS1 206a is coupled to GWs 204a and 204c (as indicated by the larger dashed lines) via the signalling links shown. Furthermore, as shown in FIG. 2A, multiple RNSs can share a GW. In addition to performing other functions, each GW 204a-c can be used to terminate an A-interface. Also, as described earlier, each such GW can convert from one protocol to another protocol. Each RNS 206a-c can be used to implement one or more logical BSCs, each of which is recognized by respective MSCs 210a-c.

As mentioned above, one or more RBSs and GWs are controlled by a respective RNS. A BSS Network Resource Management function (not shown) defines the functional and/or operational relationships between the RNSs, GWs and RBSs. In any event, the RNSs are responsible for establishing signalling connections towards their respective GWs and RBSs.

In one aspect of the preferred embodiment, the processing platforms are located appropriately throughout the BSS network topology so that the mapping of RNSs to RBSs can be accomplished freely. Consequently, for example, if an RNS becomes inoperable, another platform can be implemented to take over the responsibilities of the inoperable RNS. The second processing platform is configured to carry the extra load from the first RNS, and sufficient bandwidth is made available so that the second processing platform can handle the extra load. Notably, as one implementation for this exemplary embodiment, at least one standby RNS 212 is provided to handle the load for a failed or inoperable primary RNS 206a-c. Preferably, as insurance against the occurrence of a catastrophic event at one or more primary RNS's locations, the standby RNS 212 is located at a different site away from the primary RNSs 206a-c. With such a standby RNS, the network can recover relatively quickly after, for example, a processor outage.

In a second aspect of the preferred embodiment, the load from a failing RNS (e.g., RNS1 206a) is distributed to some or all of the other RNSs (e.g., RNS2 206b and RNS3 206c). Preferably, in this case, each RNS 206a-c is operated at less than a maximum load. Enough spare capacity is thus maintained in each RNS so that if one RNS starts to fail, the remaining RNSs can be directed to take over the load from the failing RNS.

Advantageously, for the preferred embodiment, the core network made up of MSCs 210a-c, Visitor Location Registers (VLRs), and Home Location Registers (HLRs) is not affected by the reconfiguration of the BSS 200 to implement a standby RNS or the redistribution of a failing RNS's load. Therefore, the configurations of the Location Areas/Routing Areas (LA/RA) are also not affected. Note that an LA/RA is the location of a subscriber known outside the BSS. The MSC/VLR has stored information about the logical BSC that the MSC/VLR shall address for paging, and this BSC sends page messages over all RBSs in the LA/RA. As such, an MSC can continue to be coupled to an LA through the same GW both before and after reconfiguration of the RNSs. For example, after reconfiguration of the RNSs is completed in accordance with the preferred embodiment, MSC1 210a can continue to be coupled to LA-b through GW1 204a, MSC2 210b can continue to be coupled to LA-x through GW2 204b, and MSC3 210c can continue to be coupled to LA-a through GW3 204c.

For this embodiment, the reconfiguration of the RNSs that are to take over from a failing RNS can be planned in advance by an operator so that an entire LA/PA is maintained under one RNS. As such, enough processor capacity has to be reserved so that a “takeover” RNS can handle one or more “new” LA/PAs. Notably, as described above, a standby RNS 212 can be implemented to provide the required reserve processor capacity.

In accordance with the preferred embodiment of the present invention, an example of an RNS failure and different LA/RA is now described for illustrative purposes. Referring again to FIG. 2A, it can be assumed for this example, that all primary RNSs 206a-c are serving different LA/RA(s). Also, assume that RNS1 206a implements BSC1 and BSC2, RNS2 206b implements BSC3, RNS3 206c implements BSC4, BSC1 implements LA-b, and BSC2 implements LA-a. Next, assume that RBS1 202a belongs to LA-a, and RBS2 202b and RBS3 202c belong to LA-b.

For this example, assume that RNS1 206a becomes inoperable. Subsequently, each RBSs1-3 202a-c eventually recognizes that RNS1 206a is not responding. Consequently, RBSs1-3 202a-c attempt to find another RNS that can serve them. Prior to the failure of RNS1 206a, each RBS1-3 202a-c obtained from a Dynamic Host Configuration Protocol (DHCP) server 213a-b, their respective IP address and other related IP data, and the addresses of the available Lookup Servers (LSs) 214a-b. Note however, that although DHCP servers can be used for obtaining the address data and related data as described directly above, the invention is not limited to the use of a DHCP server, and any other appropriate apparatus and/or method can be used to retrieve such data.

Next, the RBSs1-3 202a-c each contact a first LS (e.g., LS1 214a) and attempt to find the address of an appropriate RNS that can serve them (RBSs1-3 202a-c). If the first LS (e.g., LS1 214a) is not available, then the RBSs1-3 can contact a second LS (e.g., LS2 214b) for the same purpose. In response, the available LS provides to the RBSs1-3 202a-c the address of an RNS (e.g., RNS2 206b) that can serve RBS2-3 202b-c, and another RNS (e.g., RNS3 206c) that can serve RBS1 202a. In other words, for this example, the available LS has been setup (e.g., by the operator) so that the RBSs belonging to LA-b are directed to RNS2 206b, and the RBSs belonging to LA-a are directed to RNS3 206c.

Next, each RBS2-3 202b-c registers itself (each with a unique address) with RNS2 206b, and RBS1 202a registers itself with RNS3 206c. If either RNS2 206b and RNS3 206c do not have the appropriate configuration data, that RNS contacts the Operation and Maintenance (O&M) system 216 to obtain the configuration data for the particular RBS1-3 202a-c involved. This configuration data can also include the data for all cells that the RBSs1-3 implement. Once RNS2 206b and RNS3 206c have retrieved the required configuration data, the RBSs1-3 202a-c are thus configured and can begin to carry traffic again.

For this embodiment, the RBSs are preferably ranked in priority order by the network operator so that certain RBSs at particularly critical locations are to be started up first after the reconfiguration. Also, if a selected RNS (e.g., RNS2 206b) has limited processor capacity available (and no other RNS is available), only the highest priority RBSs (e.g., determined in advance by the operator) are to be started up again. Alternatively, each RBS can use its own priority ranking to adapt the length of a timeout period before it can contact the LS or RNS. This approach avoids a potential glut of RBSs simultaneously attempting to make contact with the LS or RNS. In any event, the LS can be configured by the O&M system 216, which can allow an operator to decide in advance how any network reconfiguration should take place.

When an RBS registers with an RNS, the RNS determines from the obtained cell data whether or not the “new” RBS belongs to a new LA/RA. If the “new” RBS belongs to an LA/RA that was not previously supported by that RNS, that RNS sets up a signalling connection with the appropriate GW through which the MSC involved is to communicate. Alternatively, the GW can also set up the relationship between itself and the RNS.

FIG. 2B is a block diagram that shows the BSS 200 after a network reconfiguration has been completed in accordance with the system and method described above with respect to FIG. 2A. As shown in FIG. 2B, RNS2 206b has taken control over BSC1 and LA-b. Consequently, RNS2 206b establishes a signalling connection with MSC1 210a through GW1 204a. Also, although RNS3 206c already has a signalling connection established with MSC3 210c for BSC4, RNS3 206c still establishes a signalling connection through GW3 204c for BSC2.

A third aspect of the preferred embodiment will now be described for illustrative purposes. As an alternative method for configuring an IP-based mobile communications network, such as for example, in the IP-based BSS 200 described above, the operational and functional relationships between the RNSs, RBSs and GWs shown in FIG. 2A can be initially defined in the O&M system 216. The O&M system 216 configures each RBS with information about which RNS with which to register. The O&M system can provide an RBS with the IP address or name of an RNS. In the latter case, the RBS can retrieve the IP address of the RNS from, for example, a name server.

The O&M system 216 can configure the RNS with information about which cells the RNS should handle, and also data for each such cell. The O&M system can also configure the RNS, for each cell, with the identity of the RBS (or part of the RBS representing, for example, an antenna sector) that should support each such cell. When an RBS registers itself with such an RNS, the associated cell-handling application in the RNS is notified. The RNS then establishes at least one communication link with the RBS, and configures the RBS (or part thereof) with cell data.

For this exemplary aspect of the embodiment, there is at least one communication link (e.g., over IP) between the O&M system 216 and the RNS, and at least one communication link (e.g., over IP) between that RNS and each RBS. For example, these links can be supervised by so-called “heartbeats”. In case of an RNS failure, the failure can be detected by the O&M system, one or more RBSs, or both the O&M system and the RBSs. Each RBS will, after some elapsed time to filter out disturbances in the communication, act upon detecting a communication fault (e.g., take a cell out of operation). Each RBS can also send an alarm to the O&M system, whereby the alarm indicates a loss of communications towards an RNS.

The O&M system can receive a plurality of alarms from RBSs supported by a specific RNS, and can also detect a communication fault between itself and that RNS. As such, the O&M system can conclude that RNS is out of service. Consequently, the O&M system will begin to reconfigure the network in accordance with a stored procedure (e.g., pre-planned by the operator). Alternatively, the O&M system 216 can notify the operator that, for example, an RNS is out of service, and then the operator can decide how to act in response to such a situation.

As another alternative, if a standby RNS (e.g., 212) is available, the O&M system or the operator can assign the RBSs, which have lost their RNS, to the standby RNS. The RBSs and standby RNS can then be reconfigured by the method described directly above for the RBSs and a primary RNS.

Although a preferred embodiment of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. A system for maintaining availability of network resources in an IP-based system, comprising:
at least one primary radio network server, said at least one primary radio network server coupled to an IP network in said IP-based system and associated with at least one location area;
at least one radio base station, said at least one radio base station coupled to said at least one primary radio network server and said IP network for communication therebetween;
at least one secondary radio network server coupled to said IP network; and
a lookup medium coupled to said IP network, said lookup medium operable to store address information associated with said at least one secondary radio network server, and responsive to an operational failure of said at least one primary radio network server, said at least one radio base station operable to retrieve said address information and connect to said at least one secondary radio network server.

2. The system of claim 1, wherein said lookup medium comprises a lookup server.

3. The system of claim 1, wherein said lookup medium comprises a DHCP server.

4. The system of claim 1, wherein said lookup medium comprises a database.

5. The system of claim 1, wherein said system further comprises an IP-based Base Station System.

6. The system of claim 1, wherein said at least one secondary radio network server further comprises a standby Radio Network Server.

7. A system for maintaining availability of network resources in an IP-based system, comprising:
a plurality of radio network servers, each of said plurality of radio network servers coupled to an IP network in said IP-based system and associated with at least one location area;
at least one radio base station, said at least one radio base station coupled to a first radio network server of said plurality of radio network servers and said IP network for communication therebetween; and
a lookup medium coupled to said IP network, said lookup medium operable to store address information associated with said each of said plurality of radio network servers, and responsive to an operational failure of said first radio network server, said at least one radio base station operable to retrieve said address information and connect to at least a second radio network server of said plurality of said radio network servers.

8. The system of claim 7, wherein said at least one radio base station is selected for communication with said at least a second radio network server based on a priority ranking associated with a plurality of radio base stations.

9. The system of claim 7, wherein said lookup medium comprises a lookup server.

10. The system of claim 7, wherein said lookup medium comprises a DHCP server.

11. The system of claim 7, wherein said lookup medium comprises a database.

12. The system of claim 7, wherein said system further comprises an IP-based Base Station System.

13. A method for maintaining availability of network resources in an IP-based system, comprising the steps of:
coupling at least one primary radio network server to an IP network in said IP-based system;
associating said at least one primary radio network server with at least one location area;
coupling at least one radio base station to said at least one primary radio network server and said IP network for communication therebetween;
coupling at least one secondary radio network server to said IP network;
storing in a lookup medium address information associated with said at least one secondary radio network server; and
said at least one radio base station retrieving said address information and connecting to said at least one secondary radio network server responsive to an operational failure of said at least one primary radio network server.

14. The method of claim 13 wherein said lookup medium comprises a lookup server.

15. The method of claim 13, wherein said lookup medium comprises a DHCP server.

16. The method of claim 13, wherein said lookup medium comprises a database.

17. The method of claim 13, wherein said system further comprises an IP-based Base Station System.

18. The method of claim 13, wherein said at least one secondary radio network server further comprises a standby Radio Network Server.

19. A method for maintaining availability of network resources in an IP-based system, comprising:
coupling a plurality of radio network servers to an IP network in said IP-based system;
associating each of said plurality of radio network servers with at least one location area;
coupling at least one radio base station to a first radio network server of said plurality of radio network servers and said IP network for communication therebetween; and
storing in a lookup medium address information associated with said each of said plurality of radio network servers; and
said at least one radio base station retrieving said address information and connecting to at least a second radio network server of said plurality of said radio network servers, responsive to an operational failure of said first radio network server.

20. The method of claim 19, wherein said at least one radio base station is selected for communication with said at least a second radio network server based on a priority ranking associated with a plurality of radio base stations.

21. The method of claim 19, wherein said lookup medium comprises a lookup server.

22. The method of claim 19, wherein said lookup medium comprises a DHCP server.

23. The method of claim 19, wherein said lookup medium comprises a database.

24. The method of claim 19, wherein said system further comprises an IP-based Base Station System.
